(19) United States
(12) Patent Application Publication
(10) Pub. No.: US 2018/0285824 A1
(43) Pub. Date: Oct. 4, 2018

(54) SEARCH BASED ON INTERACTIONS OF SOCIAL CONNECTIONS WITH COMPANIES OFFERING JOBS

(71) Applicant: Linkedln Corporation, Sunnyvale, CA (US)

(72) Inventors: Krishnaram Kenthapadi, Sunnyvale, CA (US); Kaushik Rangadurai, Sunnyvale, CA (US); Bo Zhao, Redwood City, CA (US)

(21) Appl. No.: 15/478,843

(22) Filed: Apr. 4, 2017

(51) Int. Cl. G06Q 10/10; G06Q 50/00; G06F 17/30; G06N 99/00

(52) U.S. Cl. CPC G06Q 10/1053; G06N 99/005; G06F 17/3053; G06Q 50/01

(57) ABSTRACT

Methods, systems, and computer programs are presented for ranking jobs for presentation to a user to present jobs that are trending due to popular demand among members of the social network that have similar job interests as the user. The jobs are presented within a trending-jobs group, which is part of a job presentation user interface. One method includes operations for identifying jobs presentable to the user, and for determining proxy members that are similar to the user. For each job, a server determines a job-interaction score based on the interactions of the proxy members with the job and the similarity between the user and the proxy users. The server additionally ranks the jobs based on the job-interaction score for each job and displays the jobs within the trending-jobs group for the user.

### TECHNICAL FIELD

The subject matter disclosed herein generally relates to methods, systems, and programs for finding quality job offerings for a member of a social network.

### BACKGROUND

Some social networks provide job postings to their members. The member may perform a job search by entering a job search query, or the social network may suggest jobs that may be of interest to the member. However, current job search methods may miss valuable opportunities for a member because the job search engine limits the search to specific parameters. For example, the job search engine may look for matches in the job title with the member's title, but there may be quality jobs that are associated with a different title that would be of interest to the member.

Further, existing job search methods may focus only on the job description or the member's profile, without considering the member's preferences for job searches that go beyond the job description or other information that may help find the best job postings for the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture, according to some example embodiments, including a social networking server.

FIG. 2 is a screenshot of a user interface that includes job recommendations, according to some example embodiments.

FIG. 3 is a screenshot of a user's profile view, according to some example embodiments.

FIG. 4 is a diagram of a user interface, according to some example embodiments, for presenting job postings to a member of a social network.

FIG. 5 is a detail of a trending-jobs group area in a user interface, according to some example embodiments.

FIG. 6 illustrates the scoring of a job for a member, according to some example embodiments.

FIG. 7 further shows scoring the job for the member while incorporating groups, according to some embodiments.

FIG. 8 is a diagram that depicts various interactions between members on the social network and jobs offered, according to some embodiments.

FIG. 9 is a diagram that depicts skill similarities between a searching member and proxy members on the social network and also interactions by the proxy members with jobs offered on the social network, according to some embodiments.

FIG. 10 illustrates the training and use of a machine-learning program, according to some example embodiments.

FIG. 11 illustrates a method for identifying similarities among skills, according to some example embodiments.

FIG. 12 illustrates the trend analysis system for implementing example embodiments.

FIG. 13 is a flowchart of a method, according to some example embodiments, for determining trending jobs for presentation to a member.

FIG. 14 is a block diagram illustrating an example of a software architecture that may be installed on a machine, according to some example embodiments.

FIG. 15 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to grouping job postings for presentation to a user in response to a search. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One of the goals of the present embodiments is to personalize and redefine how job postings are searched and presented to job seekers. Another goal is to explain better why particular candidate jobs are recommended to the job seekers. The presented embodiments provide, to both active and passive job seekers, valuable job recommendation insights, thereby greatly improving their ability to find and assess jobs that meet their needs.

Instead of providing a single job recommendation list for a member, embodiments presented herein define a plurality of groups, and the job recommendations are presented within the groups. Each group provides an indication of a feature that is important to the member for selecting jobs for the group, such as how many people have transitioned from the university of the member to the company of the job, who would be a virtual team for the member if the member joined the company, jobs that are trending, and so forth. Thus, the embodiments are able to provide insight into the methods of job selection to the user by providing groups of jobs, with all jobs in the group sharing one or more features. Thus, the user is given insight into why certain jobs are presented within a particular group.

Embodiments presented herein determine jobs that are popular among proxy members, which have similar skills to the searching member, by tracking the interactions of the proxy members with the jobs. Thus, a value can be presented to a member of how the jobs are trending among proxy members. In some embodiments, one or more companies that are offering the trending jobs are presented to the user. In this way, a system can analyze data to compare proxy members with a searching member and determine a job-interaction score for a job based on the similarity between the searching member and the proxy members as well as the interactions by the proxy members with the job.

One general aspect includes a method for determining a first skill set for the searching member on a social network, the first skill set including at least one skill from the user profile. The method also includes operations for identifying jobs listings that are offered by companies. The method also includes operations for identifying one or more proxy members having skills similar to the skills of the searching member. The method also includes operations for calculating a job-interaction score based on a level of interaction between the proxy members and the job. The method also includes operations for ranking the jobs based on the job-interaction scores and for presenting the jobs within a trending-jobs group area in an order based on the ranking.

In some embodiments the first skill set includes one or more skills that are calculated using a machine learning tool, and the calculations are based on a similarity score that measures a similarity between the first skill set and a second skill set of a second member. In some embodiments, the level of interaction between the plurality of members and the job is based on an aggregation of member interactions, the member interactions being instances of a proxy member applying for the job, viewing the job, or sharing the job. Further, in some embodiments, the job-interaction score is further based on a value of member interactions by proxy members being met, by proxy members being employed at the company offering the job, or by proxy members sharing a common location with the searching member. In some embodiments, the job-interaction score is based on a job affinity score, the job affinity score being a measure of a degree of matching attributes between attributes of the first member and attributes of the job. In some embodiments, the method further includes calculating a company trend score based on the job interaction scores of jobs offered by the company, ranking the companies based on company trend score, and causing presentation of the companies in a user interface based on the ranking.

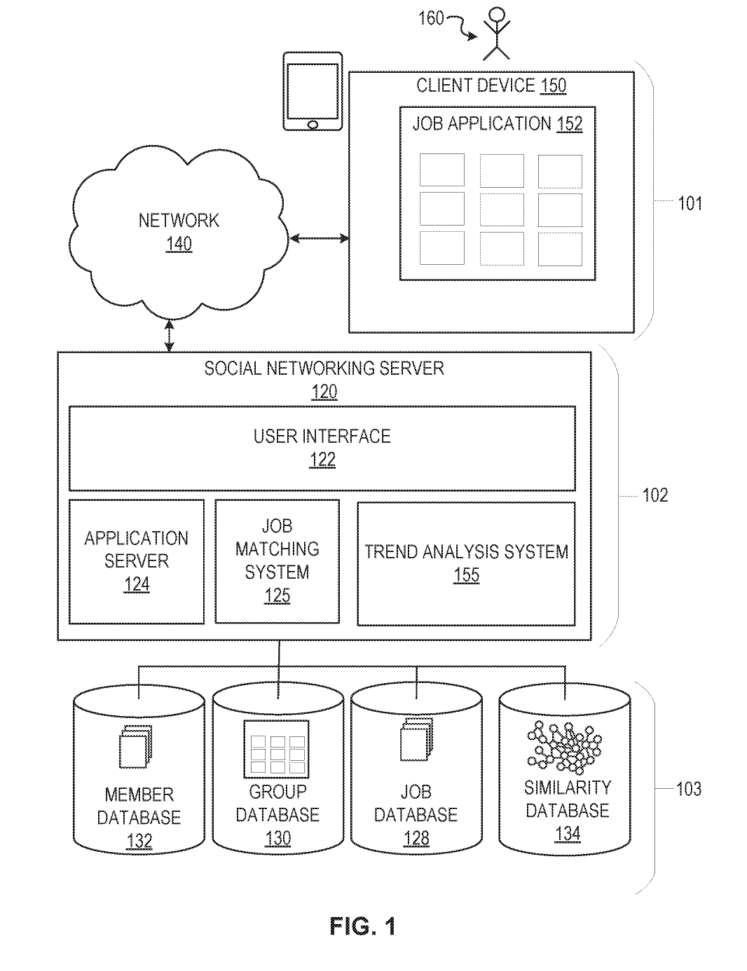

FIG. 1 is a block diagram illustrating a network architecture, according to some example embodiments, including a social networking server 120. As shown in FIG. 1, the network architecture includes three layers: a data layer 103, an application logic layer 102, and a device layer 101. The layers communicate over a network 140 (e.g., the Internet). The data layer 103 includes several databases, including a member database 132 for storing data for various entities of the social networking server 120, including member profiles, company profiles, and educational institution profiles, as well as information concerning various online or offline groups. Of course, in various alternative embodiments, any number of other entities might be included in the social graph, and as such, various other databases may be used to store data corresponding with other entities.

Consistent with some embodiments, when a person initially registers to become a member of the social networking server 120, the person will be prompted to provide some personal information, such as his or her name, age (e.g., birth date), gender, interests, contact information, home town, address, spouse's and/or family members' names, educational background (e.g., schools, majors, etc.), current job title, job description, industry, employment history, skills, professional organizations, interests, and so on. This information is stored, for example, as member attributes in the member database 132.

Additionally, the data layer 103 includes a job database 128 for storing job data. The job data includes information collected from a company offering a job, including experience required, location, duties, pay, and other information. This information is stored, for example, as job attributes in the job database 128.

Additionally, the data layer 103 includes a similarity database 134 for storing data related to calculating a similarity between members. The data layer 130 additionally includes company data, such as company name, industry associated with the company, number of employees at the company, address of the company, overview description of the company, and job postings associated with the company. Additionally, the company data includes a benefit value that measures benefits experienced by employees that work for the company. The benefit value may be determined by assessing various features, including the provision of company meals, rate of promotion within the company, vacation time, and starting salary.

Once registered, a member may invite other members, or be invited by other members, to connect via the social networking server 120. A “connection” may specify a bilateral agreement by the members, such that both members acknowledge the establishment of the connection. Similarly, in some embodiments, a member may elect to “follow” another member. In contrast to establishing a connection, the concept of “following” another member typically is a unilateral operation, and at least in some embodiments, does not prompt acknowledgement or approval by the member who is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking server 120. In some example embodiments, because the content selection algorithm selects content relating to or associated with the particular entities that a member is connected with or is following, as a member connects with and/or follows other entities, the universe of available content items for presentation to the member in his or her content stream increases.

Additionally, the data layer 103 includes a group database 130 for storing group data. The group database 130 includes information about groups (e.g., clusters) of jobs that have job attributes in common with each other. The group data includes various group features comprising a characteristic for the group, as discussed in more detail below. This information is stored, for example, as job attributes in the job database 128.

As members interact with various applications, content, and user interfaces of the social networking server 120, information relating to the member's activity and behavior may be stored in a database, such as the member database 132 and the job database 128.

The social networking server 120 may provide a broad range of other applications and services that allow members the opportunity to share and receive information, often customized to the interests of the member. In some embodiments, members of the social networking server 120 may be able to self-organize into groups, or interest groups, around a subject matter or a topic of interest. In some embodiments, members may subscribe to or join groups affiliated with one or more companies. For instance, in some embodiments, members of the social networking server 120 may indicate an affiliation with a company at which they are employed, such that news and events pertaining to the company are automatically communicated to the members in their personalized activity or content streams. In some embodiments, members may be allowed to subscribe to receive information concerning companies other than the company with which they are employed. Membership in a group, a subscription or following relationship with a company or group, and an employment relationship with a company are all examples of different types of relationships that may exist between different entities, as defined by the social graph and modeled with social graph data of the member database 132.

The application logic layer 102 includes various application server modules 124, which, in conjunction with a user interface module 122, generate various user interfaces with data retrieved from various data sources or data services in the data layer 103. In some embodiments, individual application server modules 124 are used to implement the functionality associated with various applications, services, and features of the social networking server 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, the social networking server 120 may include a job matching system 125, which creates a job display on a job application 152 on a client device 150. Also included in the social networking server 120 is a trend analysis system 155, which calculates job-interaction scores, each job-interaction score being between a proxy member on the social network and a job, and causes the job-interaction score to be viewable on the job application 152 by a searching member 160.

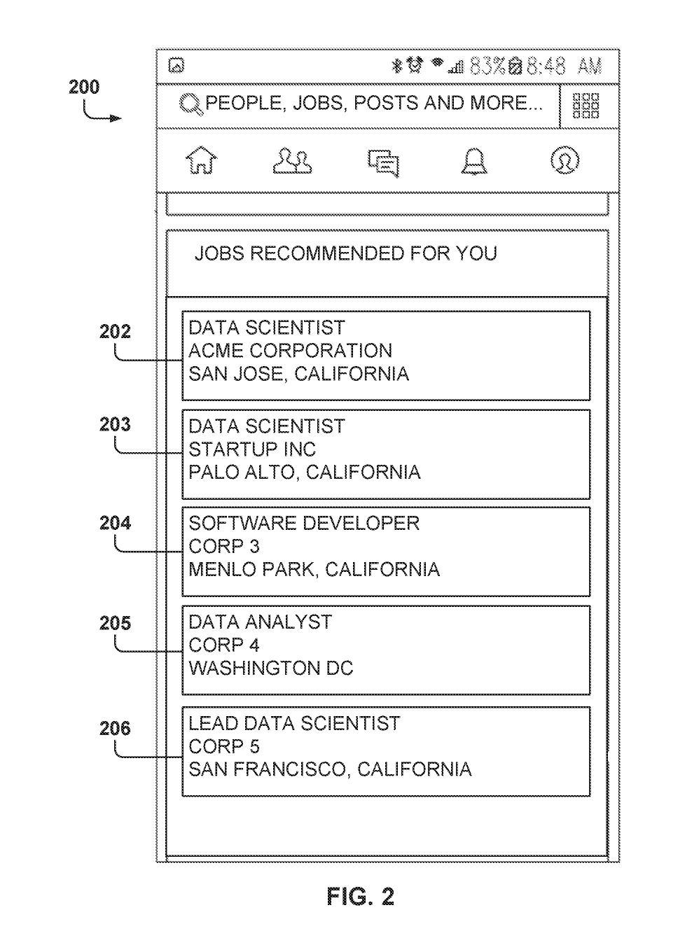

FIG. 2 is a screenshot of a user interface 200 that includes recommendations for jobs 202-206 within the job application 152, according to some example embodiments. In one example embodiment, the social network user interface provides job recommendations, which are job postings that match the job interests of the user and that are presented without a specific job search request from the user (e.g., job suggestions).

In another example embodiment, a job search interface is provided for entering job searches, and the resulting job matches are presented to the user in the user interface 200.

As the user scrolls down the user interface 200, more job recommendations are presented to the user. In some example embodiments, the job recommendations are prioritized to present jobs in an estimated order of interest to the user.

The user interface 200 presents a “flat” list of job recommendations as a single list. Other embodiments presented below utilize a “segmented” list of job recommendations where each segment is a group that is associated with a related reason indicating why these jobs are being recommended within the group.

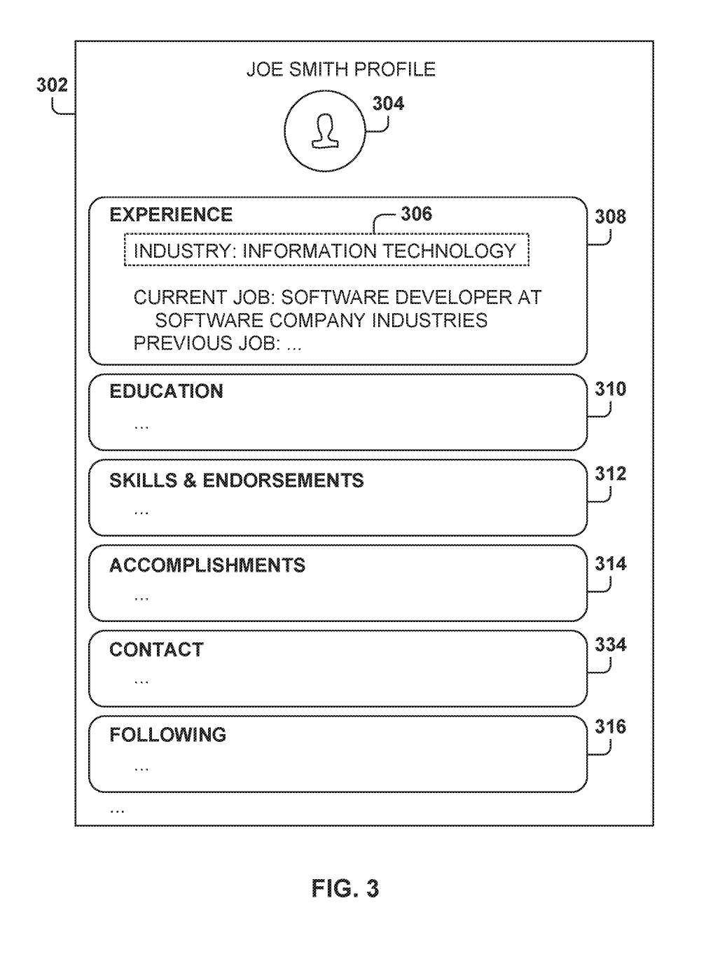

FIG. 3 is a screenshot of a user's profile view, according to some example embodiments. Each user in the social network has a member profile 302, which includes information about the user. The member profile 302 is configurable by the user and also includes information based on the user's activity in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the member's account may be associated with the number of endorsements received for each skill from other members.

The experience 308 information includes information related to the professional experience of the user. In one example embodiment, the experience 308 information includes an industry 306, which identifies the industry in which the user works. In one example embodiment, the user is given an option to select an industry 306 from a plurality of industries when entering this value in the member profile 302. The experience 308 information area may also include information about the current job and previous jobs held by the user.

The education 310 information includes information about the educational background of the user, including the educational institutions attended by the user, the degrees obtained, and the field of study of the degrees. For example, a member may list that the member attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, and the like.

The skills and endorsements 312 information includes information about professional skills that the user has identified as having been acquired by the user and endorsements entered by other users of the social network supporting the skills of the user. The accomplishments 314 area includes accomplishments entered by the user, and the contact information 334 includes contact information for the user, such as an email address and phone number. The following 316 area includes the names of entities in the social network being followed by the user.

The skills within the skills and endorsements 312 information are aggregated by the system to form a skill set for the user that can be compared to other users. In some embodiments, this skill set is part of a member characteristic for the user, the member characteristic including information such as the skill set for the user, profile information, education 310 information, and other data that is further comparable to other members.

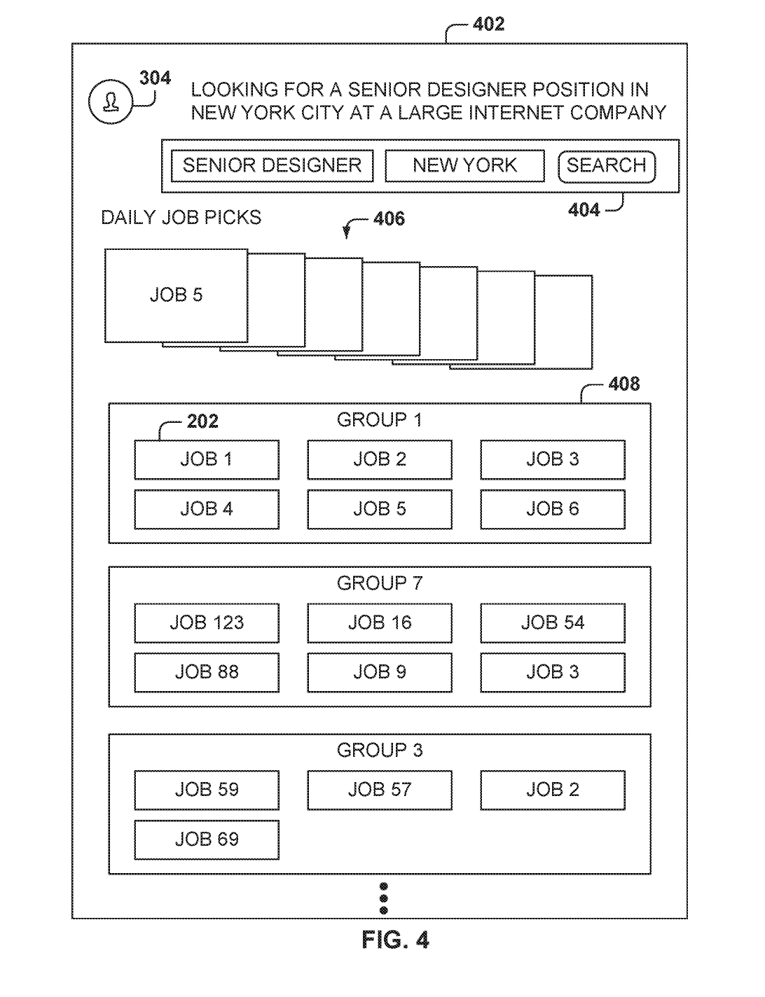

FIG. 4 is a diagram of a user interface 402, according to some example embodiments, for presenting job postings to a member of the social network. The user interface 402 includes the profile picture 304 of the member, a search section 404, a daily jobs section 406, and one or more group areas 408. In some example embodiments, a message next to the profile picture 304 indicates the goal of the search, e.g., “Looking for a senior designer position in New York City at a large Internet company.”

The search section 404, in some example embodiments, includes two boxes for entering search parameters: a keyword input box for entering any type of keywords for the search (e.g., job title, company name, job description, skill, etc.), and a geographic area input box for entering a geographic area for the search (e.g., New York). This allows members to execute searches based on keyword and location. In some embodiments, the geographic area input box includes one or more of city, state, ZIP code, or any combination thereof.

In some example embodiments, the search boxes may be prefilled with the user's title and location if no search has been entered yet. Clicking the search button causes the search of jobs based on the keyword inputs and location. It is to be noted that the inputs are optional, and only one search input may be entered at a time, or both search boxes maybe filled in.

The daily jobs section 406 includes information about one or more jobs selected for the user, based on one or more parameters, such as member profile data, search history, job match to the member, recentness of the job, whether the user is following the job, and so forth.

Each group area 408 includes one or more jobs 202 for presentation in the user interface 402. In one example embodiment, the group area 408 includes one to six jobs 202 with an option to scroll the group area 408 to present additional jobs 202, if available.

Each group area 408 provides an indication of why the member is being presented with those jobs 202, which identifies the characteristic of the group. There could be several types of reasons related to the connection of the user to the job, the affinity of the member to the group, the desirability of the job, or the time deadline of the job (e.g., urgency). The reasons related to the connection of the user to the job may include relationships between the job and the social connections of the member (e.g., “Your connections can refer you to this set of jobs”), a quality of a fit between the job and the user characteristics (e.g., “This is a job from a company that hires from your school”), a quality of a match between the member's talent and the job (e.g., “You would be in the top 90% of all applicants), and so forth.

Further, the group characteristics may be implicit (e.g., “These jobs are recommended based on your browsing history”) or explicit (e.g., “These are jobs from companies you followed”). The desirability reasons may include popularity of the job in the member's area (e.g., most-viewed by other members or most applications received), jobs from in-demand start-ups in the member's area, and popularity of the job among people with the same title as the member. Further yet, the time-urgency reasons may include “Be the first to apply to these jobs,” or “These jobs will be expiring soon.”

It is to be noted that the embodiments illustrated in FIG. 4 are examples and do not describe every possible embodiment. Other embodiments may utilize different layouts or groups, present fewer or more jobs, present fewer or more groups, etc. The embodiments illustrated in FIG. 4 should therefore not be interpreted to be exclusive or limiting, but rather illustrative.

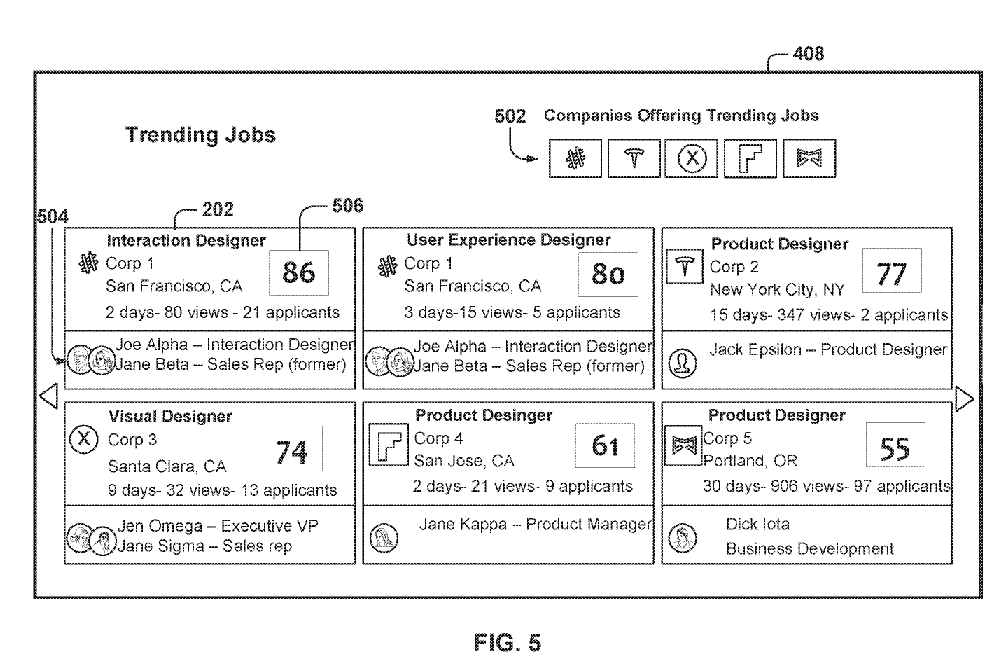

FIG. 5 is a detail of a trending-jobs group area 408 in the user interface 402, according to some example embodiments. In one example embodiment, the trending-jobs group area 408 includes recommendations of jobs 202, which provide information about one or more jobs. The trending-jobs group area 408 also lists companies 502 that are currently trending amongst proxy members. For purposes of this disclosure, a “proxy member” of a searching member is another member having a skill set that is similar to the skill set of the searching member 160.

In some example embodiments, the information about the job includes the title of the job, the company offering the job, interactions of other members with the job (number of views, number of applicants), the location of the job, and other members in the searching member's 160 social network who are currently formally employed by the company offering the job.

In one example embodiment, the group area 408 includes profile pictures 504, within the recommendations of jobs 202, of proxy members that have recently interacted with the job 202. Additionally, each job 202 includes a job-interaction score display 506 representing the level of interaction between the proxy members and the job 202.

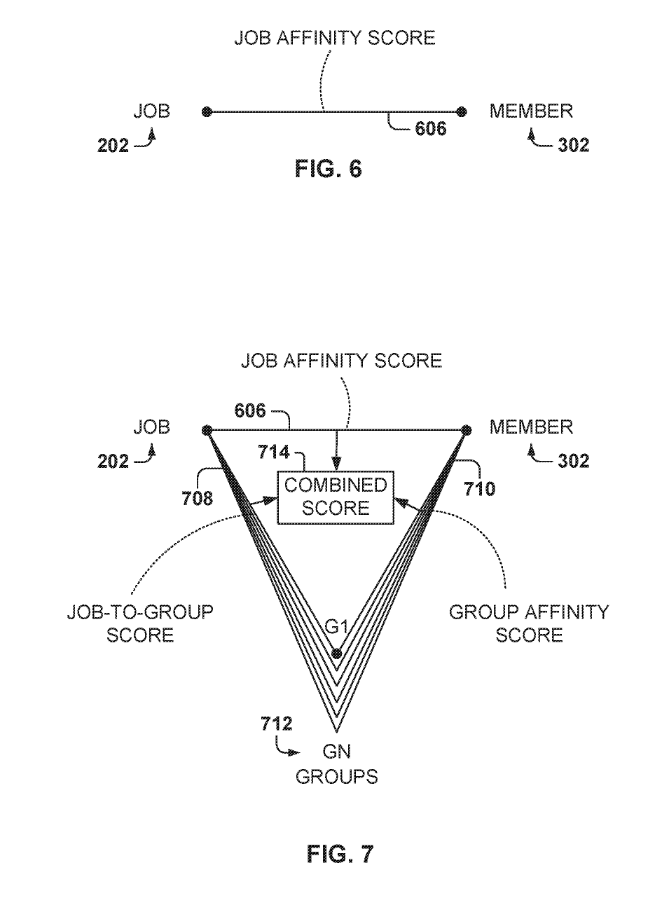

FIGS. 6-7 illustrate the scoring of a job for a member, according to some example embodiments. FIG. 6 illustrates the scoring, also referred to herein as ranking, of a job 202 for a member associated with a member profile 302 based on a job affinity score 606.

The job affinity score 606, between a job 202 and a member profile 302, is a value that measures how well the job 202 matches the interest of the member profile 302 in finding the job 202. A so-called “dream job” for a member would be the perfect job for the member and would have a high, or even maximum, value, while a job that the member is not interested in at all (e.g., in a different professional industry) would have a low job affinity score 606. In some example embodiments, the job affinity score 606 is a value between zero and one, or a value between zero and 100, although other ranges are possible.

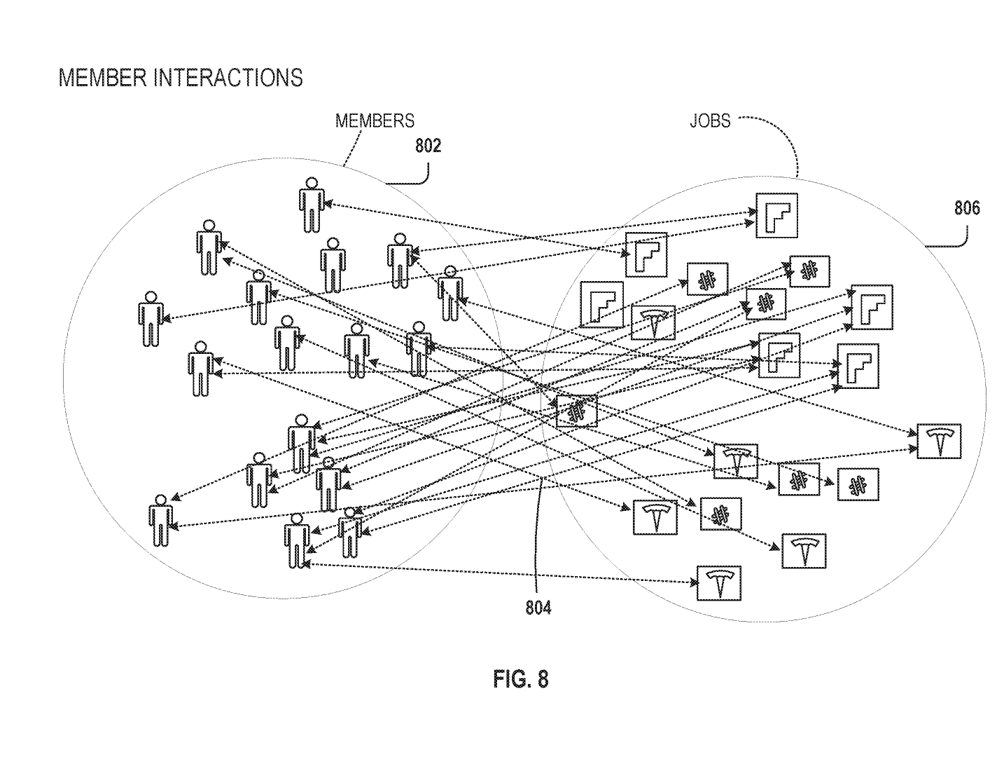

In some example embodiments, a machine-learning program is used to calculate the job affinity scores 606 for the jobs 202 available to the member. The machine-learning program is trained with existing data in the social network, and the machine-learning program is then used to evaluate jobs 202 based on the features used by the machine-learning program. In some example embodiments, the features include any combination of job data (e.g., job title, job description, company, geographic location, etc.), member profile data, member search history, employment of social connections of the member, job popularity in the social network, number of days the job has been posted, company reputation, company size, company age, profit vs. nonprofit company, and pay scale. More details are provided below with reference to FIG. 8 regarding the training and use of the machine-learning program.

FIG. 7 illustrates the scoring of a job 202 for a member associated with the member profile 302, according to some example embodiments, based on three parameters: the job affinity score 606, a job-to-group score 708, and a group affinity score 710. Broadly speaking, the job affinity score 606 indicates how relevant the job 202 is to the member, the job-to-group score 708 indicates how relevant the job 202 is to a group 712, and the group affinity score 710 indicates how relevant the group 712 is to the member.

The group affinity score 710 indicates how relevant the group 712 is to the member, where a high affinity score indicates that the group 712 is very relevant to the member and should be presented in the user interface, while a low affinity score indicates that the group 712 is not relevant to the member and may be omitted from presentation in the user interface.

The group affinity score 710 is used, in some example embodiments, to determine which groups 712 are presented in the user interface, as discussed above, and the group affinity score 710 is also used to order the groups 712 when presenting them in the user interface, such that the groups 712 may be presented in the order of their respective group affinity scores 710. It is to be noted that if there is not enough “liquidity” of jobs for a group 712 (e.g., there are not enough jobs for presentation in the group 712), the group 712 may be omitted from the user interface or presented with lower priority, even if the group affinity score 710 is high.

In some example embodiments, a machine-learning program is utilized for calculating the group affinity score 710. The machine-learning program is trained with member data, including interactions of users with the different groups 712. The data for the particular member is then utilized by the machine-learning program to determine the group affinity score 710 for the member with respect to a particular group 712. The features utilized by the machine-learning program include the history of interaction of the member with jobs from the group 712, click data for the member (e.g., a click rate based on how many times the member has interacted with the group 712), member interactions with other members who have a relationship to the group 712, and the like. For example, one feature may include an attribute that indicates whether the member is a student. If the member is a student, features such as social connections or education-related attributes will be important to determine which groups are of interest to the student. On the other hand, a member who has been out of school for 20 years or more may not be as interested in education-related features.

Another feature of interest to determine group participation is whether a job listing is trending amongst members that are similar to the searching member 160. As used herein, a job listing is considered to be “trending” when there is a high level of member activity (such as job applications, shares, and clicks) associated with the job listing compared to other job listings. The trending jobs will be more interesting to the searching member when other members, with skills similar to the skills of the searching member 160, are showing interest in these trending jobs. A benefit to presenting jobs of interest to similar members (as demonstrated via click data, page views, applications, etc.) is that the job listing's popularity stems from a unique fit of the similar members (and thus, potentially, the member) to the job. Also, trending jobs may be more popular among similar members due to better benefits offered by the company hiring for the job (such as better pay, quicker rate of promotion, etc.).

The job-to-group score 708 between a job 202 and a group 712 indicates the job 202's strength within the context of the group 712, where a high job-to-group score 708 indicates that the job 202 is a good candidate for presentation within the group 712 and a low job-to-group score 708 indicates that the job 202 is not a good candidate for presentation within the group 712. In some example embodiments, a predetermined threshold is identified, wherein jobs 202 with a job-to-group score 708 equal to or above the predetermined threshold are included in the group 712, and jobs 202 with a job-to-group score 708 below the predetermined threshold are not included in the group 712.

In the trending-jobs group, the job-to-group score 708 of a job is referred to as the job-interaction score which measures a level of interaction between the proxy members and the job 202. The job-to-group score 708 provides an indication of how important it is to present the job to the user within the trending-jobs group area 408. This is useful because an overall trend of similar people applying to a job, viewing the job, or accepting employment at the company may indicate that the job is a good employment opportunity for the searching member 160.

In some example embodiments, the interactions considered for calculating the Joe-interaction score are those occurring within a predetermined period of time, such as interactions taking place within the last month. In some example embodiments, the system may further apply a dampening effect based on the age of the interactions for calculating the job-interaction score display 506, whereby the most recent interactions are weighted with a higher value than older interactions.

In some embodiments, companies that are offering jobs that proxy members to the searching member 160 are interacting with may provide better employment opportunities for the searching member 160 than other companies. For example, the system may determine a high score for a first job based on a high surge in applications by proxy members for the first job in the past year, as well as by the fact that a high number of proxy members are also applying to jobs offered by the same company offering the first job.

In some example embodiments, the job affinity score 606, the job-to-group score 708, and the group affinity score 710 are combined to obtain a combined affinity score 714 for the job 202. The scores may be combined utilizing addition, weighted averaging, or other mathematical operations.

FIG. 8 is a diagram that depicts various interactions between members on the social network and jobs offered, according to some embodiments. FIG. 8 includes a population of members 802 of the social network. The member-job-interactions 804 depicted on FIG. 8 represent interactions of the member with the job, such as views of a job by a member, applications to the job, sharing of the job with other members, etc. Also depicted are a plurality of jobs 806 representing jobs offered on the social network. Further, displayed on each job offered within the plurality of jobs 806 is an icon indicating the company offering the job. Some of the jobs receive more interactions from the population of members 802 than others, and some of the members within the population of members 802 interact more with jobs than others.

In some example embodiments, the interactions between members and jobs on the social network are not taken into consideration after a predetermined period of time. In an example, a member view of a job is considered a member-job-interaction if it occurred within the last 12 days, although other periods of time are also possible. In another example, a member application to a job is considered a member-job-interaction if it occurred within the last 20 days, but other time thresholds are also possible, such as in the range between 3 and 180 days.

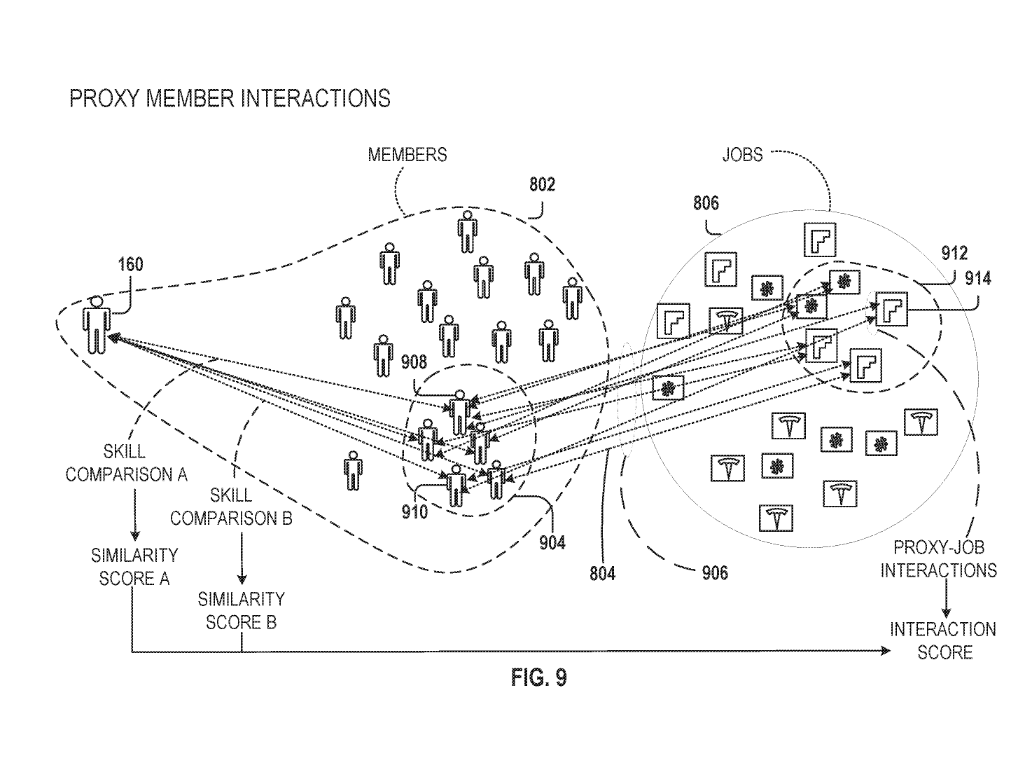

FIG. 9 is a diagram that depicts skill similarities between a searching member and other members on the social network and also interactions between these other members with jobs offered on the social network.

Also depicted in FIG. 9 is a subset of members 904 interacting with the searching member 160. The interactions between the searching member 160 and the subset of members 904 meet a certain criteria to qualify the members as proxy members. In some example embodiments, skills contained on a profile of the searching member 160 are compared to the skills on a profile of a another member 908 (skill comparison A). Further yet, skills of the searching member 160 are also compared to skills of another member 910 (skill comparison B). The system performs a skill comparison A and a skill comparison B to calculate similarity score A and similarity score B, respectively. Based on the similarity scores, the system determines that the member 908 and the member 910 both qualify as proxy members. Similarly, all the members within the subset of members 904 are determined to be proxy members.

Member-job-interactions 804 are interactions (e.g., views, applications, shares) between the subset of proxy members 904 and the plurality of jobs 806. In some example embodiments, member-job-interactions 906 that occur between proxy members and jobs define a subset 912 of jobs.

In some example embodiments, for each job within the subset 912, the system determines the job-interaction score. In some example embodiments, the job-interaction scores are based on the proxy-job-interactions between the jobs and the subset of proxy members 904 as well as the skill comparisons between the searching member 160 and the proxy members. For example, the job-interaction score IS(J) for a job J may be calculated with the following equation:

$$IS ( J ) = CN \cdot {\sum }_{i} [ {SC}_{i} ( KV \cdot {NV}_{i} ( J ) + KA \cdot {NA}_{i} ( J ) + KS \cdot {NS}_{i} ( J ) ) ]$$

Within this formula, CN is a coefficient, that the system accesses from the group database 130, based on the number of proxy members used for determining the job-interaction score IS(J). SCᵢ is the similarity score from comparing skills of the searching member with the skills of member i (e.g., skill comparison A for member A as shown on FIG. 9). KV is a view coefficient for the number of times NVᵢ(J) that the member i has viewed the job J. Similarly, KA is an application coefficient for the number of applications NAᵢ(J) submitted by member i for job J. Further, KS is a share coefficient for the number of shares NSᵢ(J) of the job J by member i. In some embodiments, the values for the view coefficient, the application coefficient, and the share coefficient are located on the group database 130.

In an example illustrated in FIG. 9, the system determines interactions scores for the subset 912 of jobs based on interactions by the proxy members. In one instance, the system uses a machine learning tool to determine a similarity scores between the searching member 160 and other proxy members. The system further determines that the first proxy member 908 and the second proxy member 910 have both engaged in proxy-job-interactions with a first job 908. The system then applies the above formula to determine a job-interaction score for the job based on the job-interaction scores and the similarity scores of the first proxy member 908 and the second proxy member 910. The system then ranks all jobs within the plurality of jobs 806 based on job-interaction score and causes display of the highest-ranked jobs within the trending-jobs group area 408.

In some example embodiments, the system uses different equations to determine the job-interaction score. In an example, the system uses a dampening formula on interaction variables NVᵢ(J), NAᵢ(J), and NSᵢ(J) based on how recently the interactions occurred. For example, if a first proxy member has viewed a first job 10 times within the past two days, this suggests a stronger trend than the same proxy member viewing a second job 10 times, but the views all occurred more than five days ago. The system can use the dampening formula to increase the value of interaction variables representing more recent interactions, such as the first job in the example. In some example embodiments, the system uses other equations to calculate the job-interaction score, including equations that make use of other statistical values such as, averages, geometric averages, logarithmic functions, algorithms, etc.

In some example embodiments, the system accesses a threshold interaction value for the jobs and calculates the job-interaction score if the threshold interaction value is met. For example, a threshold interaction value may be that the job has been viewed 18 times by at least two proxy members in the last 10 days. If the job fails to meet this threshold, the system assigns a zero job-interaction score to the job and the job is not displayed in the interaction group area.

In some example embodiments, data about the current job of a first proxy member is further used to calculate the job-interaction score between the first proxy member and a first job. For example, if the first proxy member currently holds a position that has the same job title as the first job, then the job-interaction score would be higher than if the job titles were different. Further, the first proxy member currently holding a position that the system determines (by use of machine-learning) to have a high transfer rate to the position of the first job would similarly result in a higher job-interaction score than if the first proxy member held a position that had a low transfer rate.

In some example embodiments, the location of the proxy member compared to the searching member 160 is used to calculate the job-interaction score between the proxy member and a job. For example, the searching member 160 and the proxy member living in the same city would result in a higher job-interaction score than if the searching member 160 and the proxy member lived in different cities, since it is probable that members in the same location will be interested in similar jobs.

In some example embodiments, the system utilizes the jobs that have been assigned job-interaction scores to determine a company trend score for each company based on the jobs offered by each company. In an example, the company trend score for a company is based both on number of job-interaction scores from proxy jobs offered by the company and their job-interaction scores.

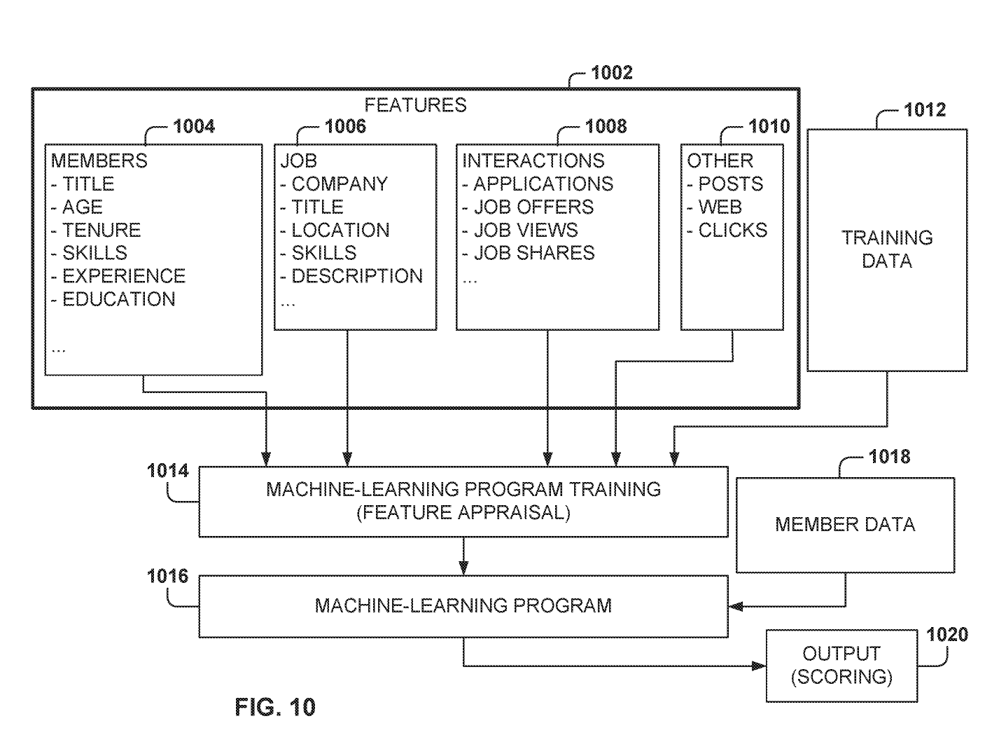

FIG. 10 illustrates the training and use of a machine-learning program 1016, according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 1012 in order to make data-driven predictions or decisions expressed as outputs or assessments (e.g., a score) 1020. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

In general, there are two types of problems in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a job affinity score 606 (e.g., a number from 1 to 100) to qualify each job as a match for the user (e.g., calculating the job affinity score 606). In other example embodiments, machine learning is also utilized to calculate the group affinity score 610 and the job-to-group score 608. The machine-learning algorithms utilize the training data 1012 to find correlations among identified features 1002 that affect the outcome.

In one example embodiment, the features 1002 may be of different types and may include one or more of member features 1004, job features 1006, interaction features 1008, and other features 1010. The member features 1004 may include one or more of the data in the member profile 302, as described in FIG. 3, such as title, skills, experience, education, and so forth. The job features 1006 may include any data related to the job 202, and the interaction features 1008 may include various data related to interactions (such as job page views, job applications, and job shares) within the social network. In some example embodiments, additional features in the other features 1010 may be included, such as post data, message data, web data, click data, and so forth.

With the training data 1012 and the identified features 1002, the machine-learning tool is trained at operation 1014. The machine-learning tool appraises the value of the features 1002 as they correlate to the training data 1012. The result of the training is the trained machine-learning program 1016.

When the machine-learning program 1016 is used to generate a score, new data, such as member data 1018, is provided as an input to the trained machine-learning program 1016, and the machine-learning program 1016 generates the score 1020 as output. For example, when a member performs a job search, a machine-learning program, such as the machine-learning program 1016, trained with similarity data, such as from the similarity database 134, uses the member data and job data from the jobs in the job database 128 to search for jobs that match the member's profile 302 and activity.

The machine-learning program 1016 may be used to determine a similarity score between the searching member 160 and a proxy member of the social network based on a comparison of skills between the searching member 160 and the proxy member. As discussed above, in some example embodiments, this similarity score is used with other similarity scores from other proxy members to calculate a job-interaction score for each job.

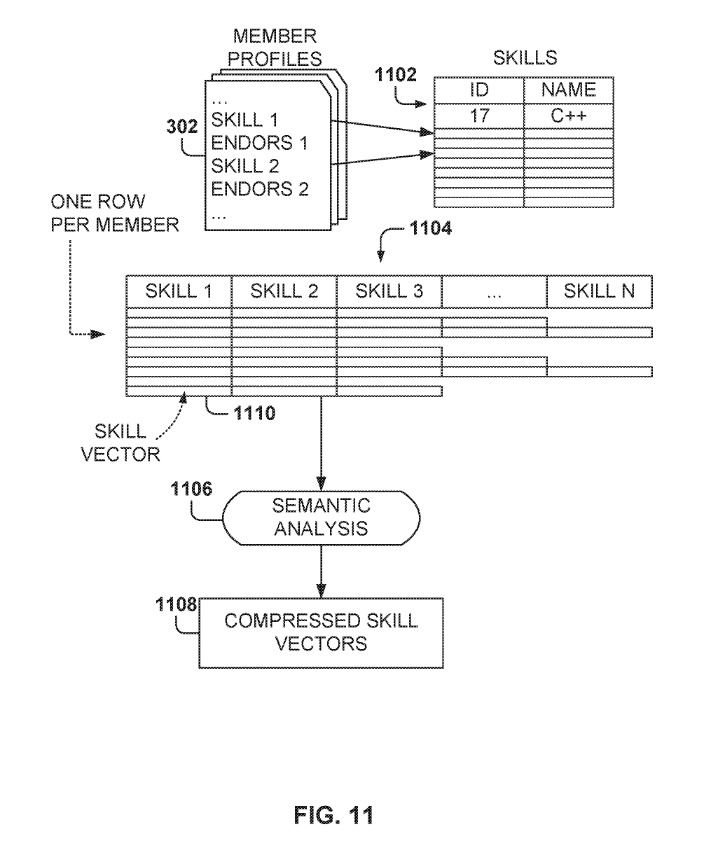

FIG. 11 illustrates a method for identifying similarities among member skills, such as by the machine-learning program 1016, according to some example embodiments. In some example embodiments, the system compares skills from the first member's skill set to skills of other members on the social network in order to determine a similarity score. In some example embodiments, the skills of the members of the social network are represented within a vector in a small dimensional space (e.g., with a dimension of 200). The vectors of the employees of the company are compared to the vector of the member searching for the job, and the employees that have similar vectors are identified as members of the virtual team.

Some example embodiments are presented for comparing member skills, but the same principles may be applied by comparing other features in addition to the skills, such as title, position, years of experience, etc., or any combination thereof. In some example embodiments, semantic vectors are created for the skills of members, and in other embodiments, the semantic vectors include the skills, the title, and the job function, for example.

Reducing vector dimension from a sparse vector representation to a compressed vector representation may be done in several ways. In one embodiment, the skills and title of each member are placed within a row, and then matrix factorization is utilized to reduce the vectors to a smaller dimension, such as 50 or 100. Then, on the reduced-dimension pace, a nearest neighbor computation from the member is performed, and can optionally be restricted to members that have engaged in member interactions with at least one job (good candidate proxy members). This way, proxy members with similar skills are found.

As used herein, the similarity coefficient between a first skill vector and a second skill vector is a real number that quantifies a similarity between the skills of the first member and the skills of the second member. The similarity coefficient is also referred to herein as the similarity value. In some example embodiments, the similarity coefficient is in the range of 0 to 1, but other ranges are also possible. In some embodiments, cosine similarity is utilized to calculate the similarity coefficient between the skill vectors.

In some example embodiments, the skill data in the skill table 1102 includes a skill identifier (e.g., an integer value) and a skill description text (e.g., C++). The member profiles 302 are linked to the skill identifier, in some example embodiments.

Semantic analysis finds similarities among member skills by creating a vector for each member such that members with similar skills have skill vectors 1108 near each other. In one example embodiment, the tool Word2vec is used to perform the semantic analysis, but other tools may also be used, such as Gensim, Latent Dirichlet Allocation (LDA), or Tensor flow.

These models are shallow, two-layer neural networks that are trained to reconstruct linguistic contexts of words. Word2vec takes as input a large corpus of text and produces a high-dimensional space (typically between a hundred and several hundred dimensions). Each unique word in the corpus is assigned a corresponding vector in the space. The vectors are positioned in the vector space such that words that share common contexts in the corpus are located in close proximity to one another in the space. In one example embodiment, each element of the skill vector 1108 is a real number.

Initially, a simple skill vector 1110 is created for each skill, where each simple skill vector 1110 includes a plurality of zeros and a 1 at the location corresponding to the skill. Afterwards, a concatenated skill table 1102 included in the member features 1004 is created, where each row includes a sequence with all the skills for a corresponding member. Thus, the first row of concatenated skill table 1102 includes all the simple skill vectors 1110 for the skills of the first member, the second row includes all the simple skill vectors 1110 for the skills of the second member, and so forth.

A semantic analysis operation 1106 is then performed on the concatenated skill table 1104. In one example embodiment, Word2vec is utilized, and the result is compressed skill vectors 1108, or simply referred to as “skill vectors,” such that members with similar skills have skill vectors 1108 near each other (e.g., with a similarity coefficient below a predetermined threshold).

Using these models, the system can determine a similarity score for a connection between a searching member 160 and a proxy member on the social network. In an example, the similarity score between the searching member 160 and a first proxy member is determined by the machine-learning program 1016 to be 0.5678 on a scale of 0 to 1. This similarity score can be used, according to the interaction formula, to weight the various interactions that the first proxy member has with a first job. Based on these weighted interactions and the weighted interactions from other proxy members, a job-interaction score for the first job can be determined.

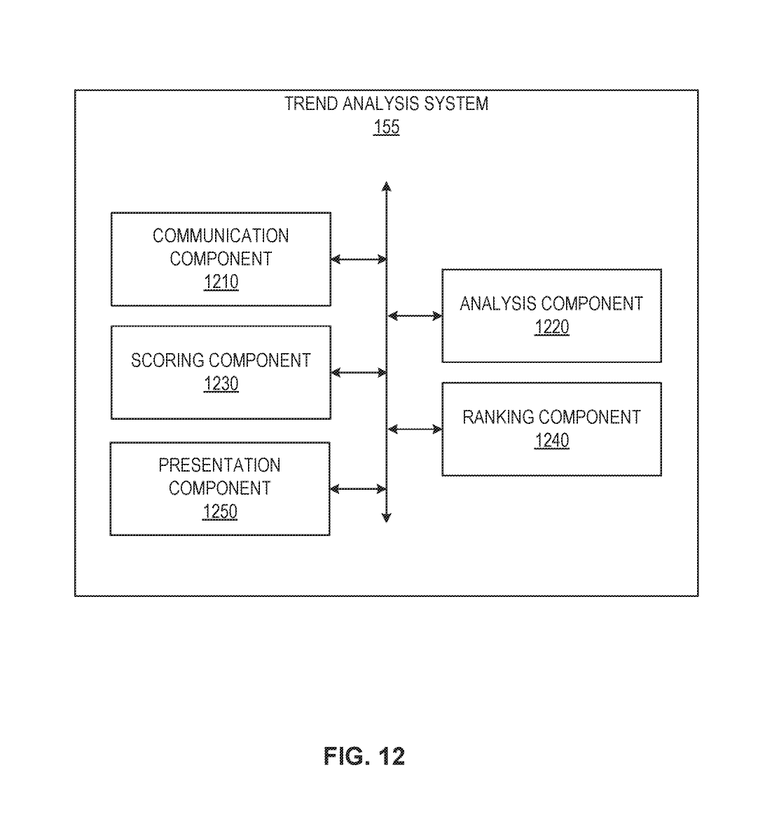

FIG. 12 illustrates the trend analysis system 155 for implementing example embodiments. In one example embodiment, the trend analysis system 155 includes a communication component 1210, an analysis component 1220, a scoring component 1230, a ranking component 1240, and a presentation component 1250.

The communication component 1210 provides various data retrieval and communications functionality. In example embodiments, the communication component 1210 retrieves data from the databases 132, 128, 130, and 134 including member data, jobs, group data, interaction features 1008, job features 1006, and member features 1004. The communication component 1210 can further retrieve data from the databases 132, 128, 130, and 134 related to rules such as threshold data, data related to a maximum number of employees to be used for generating relation scores 902 with the searching member 160, and data related to the maximum quantity of jobs displayable within the trending-jobs group area 408.

The analysis component 1220 performs operations such as determining proxy members based on a comparison of skills of the proxy members and of the searching member. This comparison may be performed using machine-learning programs 1016 described in FIG. 11. In some embodiments, the analysis component 1220 further compares groups to determine one or more groups for presentation of a job and also a presenting group for the job.

The scoring component 1230 calculates various scores as illustrated above with reference to FIGS. 6-9. The scoring component 1230 calculates the job affinity scores 606, job-to-group scores 708, group affinity scores 710, similarity scores, and job-interaction scores as illustrated above with reference to FIGS. 6-9.

The ranking component 1240 provides functionality to rank jobs by job-interaction score, as determined by the scoring component 1230, within the trending-jobs group. In some example embodiments, the jobs are ranked from highest to lowest job-interactions score.

The presentation component 1250 provides functionality to present a display of the trending-jobs group area 408 including the jobs with a display of the job-interaction score to the searching member 160, such as on the user interface 402.

It is to be noted that the embodiments illustrated in FIG. 12 are examples and do not describe every possible embodiment. Other embodiments may utilize different servers or additional servers, combine the functionality of two or more servers into a single server, utilize a distributed server pool, and so forth. The embodiments illustrated in FIG. 12 should therefore not be interpreted to be exclusive or limiting, but rather illustrative.

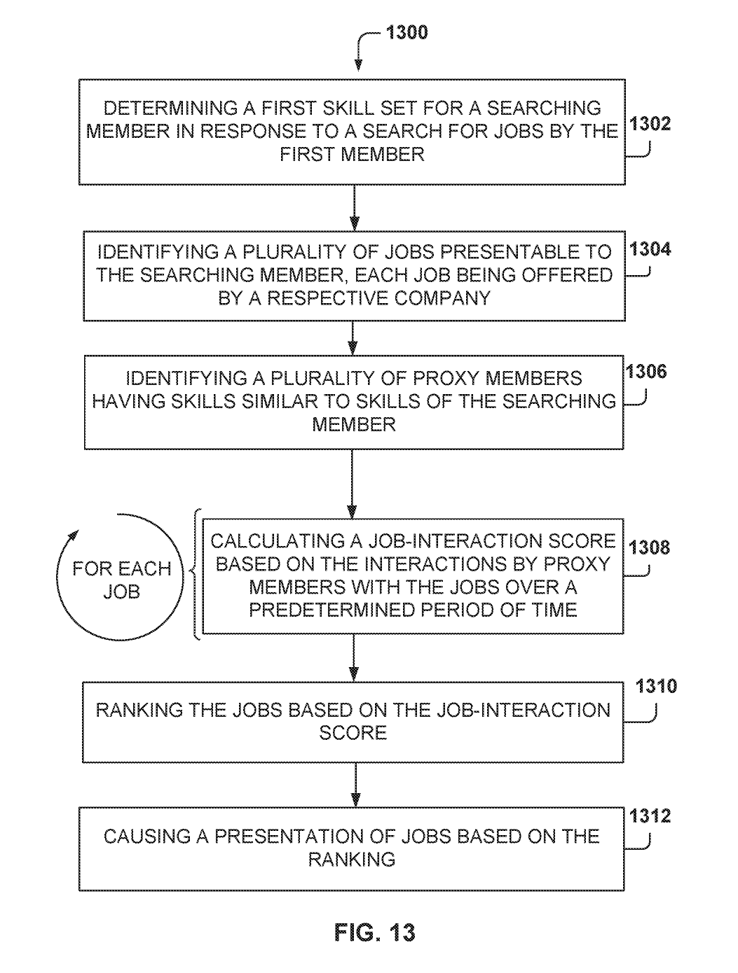

FIG. 13 is a flowchart of a method 1300, according to some example embodiments, for assigning a job-interaction score to a job in response to a search for a member. While the various operations in this flowchart are presented and described sequentially, one of ordinary skill will appreciate that some or all of the operations may be executed in a different order, be combined or omitted, or be executed in parallel.

Operation 1302 is for determining, by a server having one or more processors, a first skill set comprising skills located within the profile of the searching member 160 in response to a job search requested by the searching member 160. This can be accomplished via a machine-learning program 1016. From operation 1302, the method 1300 flows to operation 1304, where the server identifies a plurality of job listings (jobs) that are currently active and presentable to the searching member 160, each job being offered by a respective company. From operation 1304, the method 1300 flows to operation 1306, where the server identifies proxy members for each job based on a similarity of skills contained in the first skill set (from the searching member 160) and the profile of each proxy member. From operation 1306, the method 1300 flows to operation 1308, where the server calculates a job-interaction score based on interactions by proxy members with the jobs over a predetermined period of time. The interactions can include, but are not limited to, job page views, job applications, and job shares. In some embodiments, the job-interaction score is further based on a similarity score between the searching member 160 and the respective proxy members. The method 1300 then flows to operation 1310 where the jobs are ranked by the server based on the job-interaction score of each job. Finally, the method 1300 flows to operation 1312, where the system causes presentation of the jobs within the trending-jobs group area 408 based on the ranking of the jobs by trending jobs score.

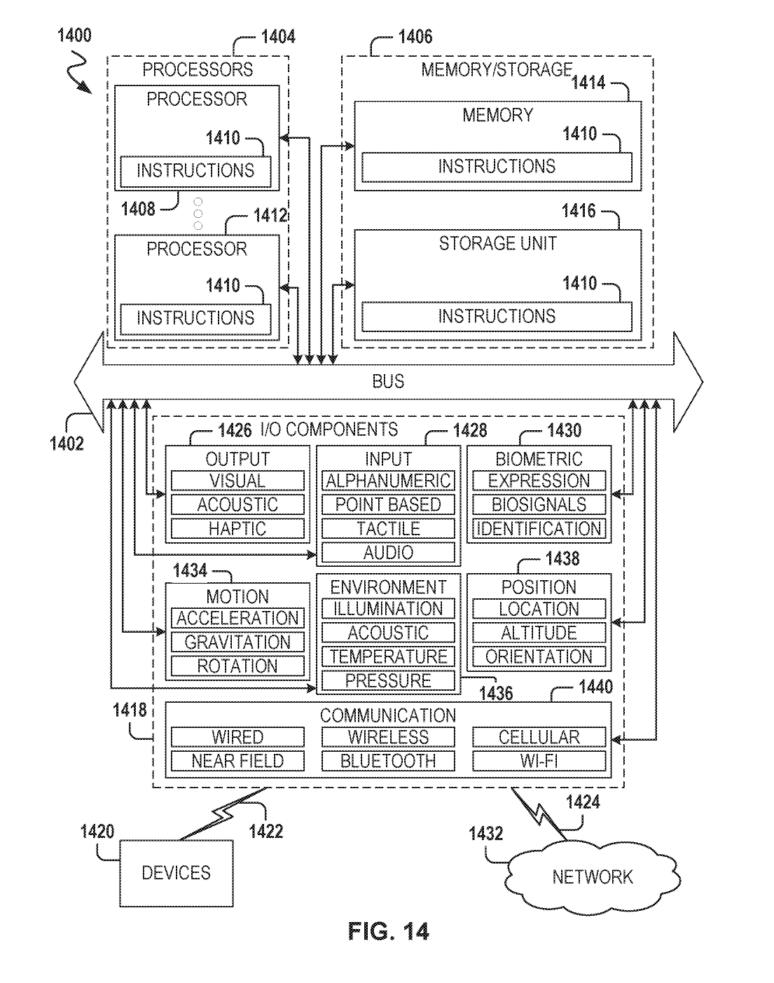

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1410 (e.g., software, a program, an application, an applet, an app, or other executable code) for causing the machine 1400 to perform any one or more of the methodologies discussed herein may be executed. For example, the instructions 1410 may cause the machine 1400 to execute the flow diagrams of FIG. 14. Additionally, or alternatively, the instructions 1410 may implement the job-scoring programs and the machine-learning programs associated with them. The instructions 1410 transform the general, non-programmed machine 1400 into a particular machine 1400 programmed to carry out the described and illustrated functions in the manner described.

In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1410, sequentially or otherwise, that specify actions to be taken by the machine 1400. Further, while only a single machine 1400 is illustrated, the term “machine” shall also be taken to include a collection of machines 1400 that individually or jointly execute the instructions 1410 to perform any one or more of the methodologies discussed herein.

The machine 1400 may include processors 1404, memory/storage 1406, and I/O components 1418, which may be configured to communicate with each other such as via a bus 1402. In an example embodiment, the processors 1404 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1408 and a processor 1412 that may execute the instructions 1410. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single core, a single processor with multiple cores (e.g., a multi-core processor), multiple processors with a single core, multiple processors with multiples cores, or any combination thereof.

The memory/storage 1406 may include a memory 1414, such as a main memory, or other memory storage, and a storage unit 1416, both accessible to the processors 1404 such as via the bus 1402. The storage unit 1416 and memory 1414 store the instructions 1410 embodying any one or more of the methodologies or functions described herein. The instructions 1410 may also reside, completely or partially, within the memory 1414, within the storage unit 1416, within at least one of the processors 1404 (e.g., within the processor's cache memory), or any suitable combination thereof, during execution thereof by the machine 1400. Accordingly, the memory 1414, the storage unit 1416, and the memory of the processors 1404 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1410. The term “machine-readable medium” shall also be taken to include any medium, or combination of multiple media, that is capable of storing instructions (e.g., instructions 1410) for execution by a machine (e.g., machine 1400), such that the instructions, when executed by one or more processors of the machine (e.g., processors 1404), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1418 may include a wide variety of components to receive input, provide output, produce output, transmit information, exchange information, capture measurements, and so on. The specific I/O components 1418 that are included in a particular machine will depend on the type of machine. For example, portable machines such as mobile phones will likely include a touch input device or other such input mechanisms, while a headless server machine will likely not include such a touch input device. It will be appreciated that the I/O components 1418 may include many other components that are not shown in FIG. 14. The I/O components 1418 are grouped according to functionality merely for simplifying the following discussion, and the grouping is in no way limiting. In various example embodiments, the I/O components 1418 may include output components 1426 and input components 1428. The output components 1426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1418 may include biometric components 1430, motion components 1434, environmental components 1436, or position components 1438 among a wide array of other components. For example, the biometric components 1430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 may include acceleration sensor components (e.g., accelerometer), gravitation sensor components, rotation sensor components (e.g., gyroscope), and so forth. The environmental components 1436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1438 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1418 may include communication components 1440 operable to couple the machine 1400 to a network 1432 or devices 1420 via a coupling 1424 and a coupling 1422, respectively. For example, the communication components 1440 may include a network interface component or other suitable device to interface with the network 1432. In further examples, the communication components 1440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1420 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as location via Internet Protocol (IP) geo-location, location via Wi-Fi® signal triangulation, location via detecting an NFC beacon signal that may indicate a particular location, and so forth.

In various example embodiments, one or more portions of the network 1432 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1432 or a portion of the network 1432 may include a wireless or cellular network and the coupling 1424 may be a Code Division Multiple Access (CDMA) connection, a Global System for Mobile communications (GSM) connection, or another type of cellular or wireless coupling. In this example, the coupling 1424 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1410 may be transmitted or received over the network 1432 using a transmission medium via a network interface device (e.g., a network interface component included in the communication components 1440) and utilizing any one of a number of well-known transfer protocols (e.g., hypertext transfer protocol (HTTP)). Similarly, the instructions 1410 may be transmitted or received using a transmission medium via the coupling 1422 (e.g., a peer-to-peer coupling) to the devices 1420. The term “transmission medium” shall be taken to include any intangible medium that is capable of storing, encoding, or carrying the instructions 1410 for execution by the machine 1400, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

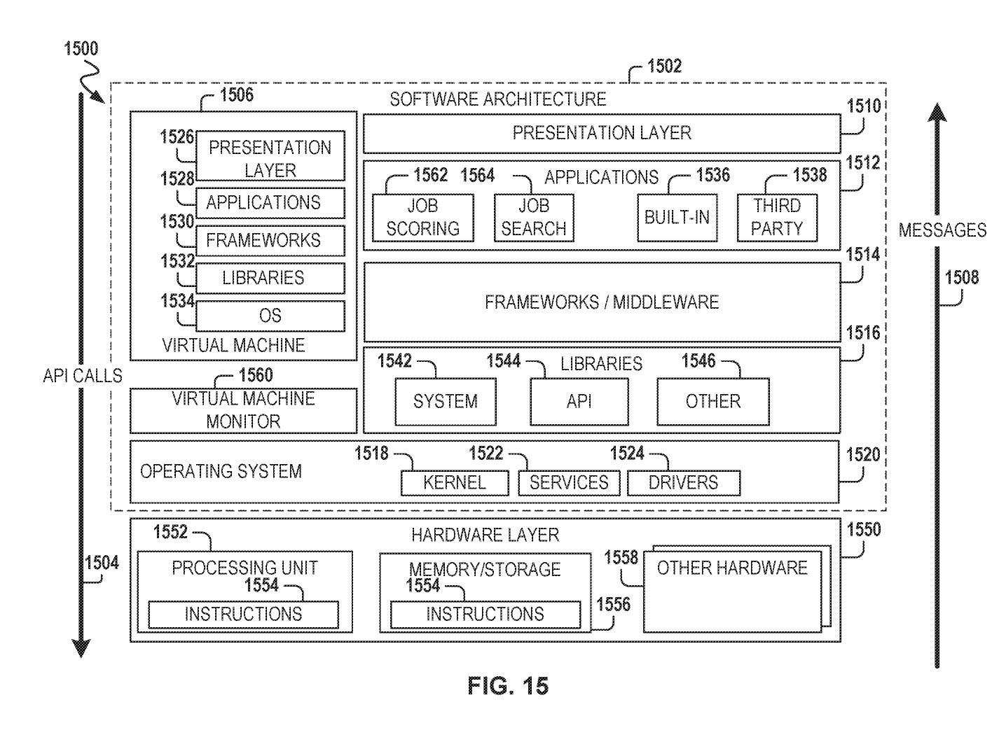

FIG. 15 is a block diagram 1500 illustrating a representative software architecture 1502, which may be used in conjunction with various hardware architectures herein described. FIG. 15 is merely a non-limiting example of a software architecture 1502, and it will be appreciated that many other architectures may be implemented to facilitate the functionality described herein. The software architecture 1502 may be executing on hardware such as the machine 1400 of FIG. 14 that includes, among other things, processors 1404, memory/storage 1406, and input/output (I/O) components 1418. A representative hardware layer 1550 is illustrated and can represent, for example, the machine 1400 of FIG. 14. The representative hardware layer 1550 comprises one or more processing units 1552 having associated executable instructions 1554. The executable instructions 1554 represent the executable instructions of the software architecture 1502, including implementation of the methods, modules, and so forth of the previous figures. The hardware layer 1550 also includes memory and/or storage modules 1556, which also have the executable instructions 1554. The hardware layer 1550 may also comprise other hardware 1558, which represents any other hardware of the hardware layer 1550, such as the other hardware illustrated as part of the machine 1400.

In the example architecture of FIG. 15, the software architecture 1502 may be conceptualized as a stack of layers where each layer provides particular functionality. For example, the software architecture 1502 may include layers such as an operating system 1520, libraries 1516, frameworks/middleware 1514, applications 1512, and a presentation layer 1510. Operationally, the applications 1512 and/or other components within the layers may invoke application programming interface (API) calls 1504 through the software stack and receive a response, returned values, and so forth illustrated as messages 1508 in response to the API calls 1504. The layers illustrated are representative in nature, and not all software architectures have all layers. For example, some mobile or special-purpose operating systems may not provide a frameworks/middleware layer 1516, while others may provide such a layer. Other software architectures may include additional or different layers.

The operating system 1520 may manage hardware resources and provide common services. The operating system 1520 may include, for example, a kernel 1518, services 1522, and drivers 1524. The kernel 1518 may act as an abstraction layer between the hardware and the other software layers. For example, the kernel 1518 may be responsible for memory management, processor management (e.g., scheduling), component management, networking, security settings, and so on. The services 1522 may provide other common services for the other software layers. The drivers 1524 may be responsible for controlling or interfacing with the underlying hardware. For instance, the drivers 1524 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1516 may provide a common infrastructure that may be utilized by the applications 1512 and/or other components and/or layers. The libraries 1516 typically provide functionality that allows other software modules to perform tasks in an easier fashion than by interfacing directly with the underlying operating system 1520 functionality (e.g., kernel 1518, services 1522, and/or drivers 1524). The libraries 1516 may include system libraries 1542 (e.g., C standard library) that may provide functions such as memory allocation functions, string manipulation functions, mathematic functions, and the like. In addition, the libraries 1516 may include API libraries 1544 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1516 may also include a wide variety of other libraries 1546 to provide many other APIs to the applications 1512 and other software components/modules.

The frameworks 1514 (also sometimes referred to as middleware) may provide a higher-level common infrastructure that may be utilized by the applications 1512 and/or other software components/modules. For example, the frameworks 1514 may provide various graphic user interface (GUI) functions, high-level resource management, high-level location services, and so forth. The frameworks 1514 may provide a broad spectrum of other APIs that may be utilized by the applications 1512 and/or other software components/modules, some of which may be specific to a particular operating system or platform.

The applications 1512 include job-scoring applications 1562, job search/suggestions 1564, built-in applications 1536, and third-party applications 1538. The job-scoring applications 1562 comprise the job-scoring applications, as discussed above with reference to FIG. 11. Examples of representative built-in applications 1536 may include, but are not limited to, a contacts application, a browser application, a book reader application, a location application, a media application, a messaging application, and/or a game application. The third-party applications 1538 may include any of the built-in applications 1536 as well as a broad assortment of other applications. In a specific example, the third-party application 1538 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1538 may invoke the API calls 1504 provided by the mobile operating system such as the operating system 1520 to facilitate functionality described herein.

The applications 1512 may utilize built-in operating system functions (e.g., kernel 1518, services 1522, and/or drivers 1524), libraries (e.g., system libraries 1542, API libraries 1544, and other libraries 1546), or frameworks/middleware 1516 to create user interfaces to interact with users of the system. Alternatively, or additionally, in some systems, interactions with a user may occur through a presentation layer, such as the presentation layer 1510. In these systems, the application/module “logic” can be separated from the aspects of the application/module that interact with a user.

Some software architectures utilize virtual machines. In the example of FIG. 15, this is illustrated by a virtual machine 1506. A virtual machine creates a software environment where applications/modules can execute as if they were executing on a hardware machine (such as the machine 1500 of FIG. 15, for example). The virtual machine 1506 is hosted by a host operating system (e.g., operating system 1520 in FIG. 15) and typically, although not always, has a virtual machine monitor 1560, which manages the operation of the virtual machine 1506 as well as the interface with the host operating system (e.g., operating system 1520). A software architecture executes within the virtual machine 1506, such as an operating system 1534, libraries 1532, frameworks/middleware 1530, applications 1528, and/or a presentation layer 1526. These layers of software architecture executing within the virtual machine 1506 can be the same as corresponding layers previously described or may be different.

What is claimed is:

1. A method comprising:
determining, by one or more processors, in response to a search for jobs for a first member of a social network, a first skill set for the first member, the first skill set being based on one or more skills identified in a profile of the first member;
identifying, by the one or more processors, a plurality of jobs presentable to the first member, each job being offered by a respective company;
identifying, by the one or more processors, a plurality of proxy members based on the proxy members having skills similar to the skills of the first member;
for each job within the plurality of jobs, calculating a job-interaction score based on a level of interaction between the plurality of proxy members and the job over a predetermined period of time;
ranking, by the one or more processors, the jobs based on the job-interaction score; and
causing presentation of the jobs in a user interface based on the ranking.

2. The method of claim 1, further comprising:
calculating a company trend score based on the job-interaction scores of jobs offered by a respective company;
ranking the respective companies based on the respective company trend scores; and
causing presentation of the companies in the user interface based on the ranking.

3. The method of claim 1, wherein the plurality of proxy members are identified based on a similarity value between the first skill set of the first member and a skill set of each proxy member, the similarity value calculated using a machine-learning program.

4. The method of claim 1, wherein the level of interaction between a member from the plurality of proxy members and the job is based on an aggregation of interactions of the member with the job, the interactions being one or more of the member applying for the job, the member viewing the job, or the member sharing the job.

5. The method of claim 4, wherein the job-interaction score is further based on a number of the aggregation of interactions exceeding a predetermined threshold value.

6. The method of claim 4, wherein the job-interaction score is further based on a number of proxy members being currently employed at a company.

7. The method of claim 1, wherein the job-interaction score is further based on a job affinity score, the job affinity score being a measure of a degree of matching attributes between attributes of the first member and attributes of the job.

8. The method of claim 1, wherein the plurality of proxy members is further identified based on a location of the proxy members in relation to a location of the searching member.

9. The method of claim 1, wherein the plurality of proxy members is further identified based on a comparison of a job title of each proxy member and a job title of the first member.

10. A system comprising:
at least one processor of a machine; and
a memory storing instructions that, when executed by the at least one processor, cause the machine to perform operations comprising:
determining, by one or more processors, in response to a search for jobs for a first member of a social network, a first skill set for the first member, the first skill set being based on one or more skills identified in a profile of the first member;
identifying, by the one or more processors, a plurality of jobs presentable to the first member, each job being offered by a respective company;
identifying, by the one or more processors, a plurality of proxy members based on the proxy members having skills similar to the skills of the first member;
for each job within the plurality of jobs, calculating a job-interaction score based on a level of interaction between the plurality of proxy members and the job over a predetermined period of time;
ranking, by the one or more processors, the jobs based on the job-interaction score; and
causing presentation of the jobs in a user interface based on the ranking.

11. The system of claim 10, wherein operations further comprise:
calculating a company trend score based on the job-interaction scores of jobs offered by a respective company;
ranking the respective companies based on the respective company trend scores; and
causing presentation of the companies in the user interface based on the ranking.

12. The system of claim 10, wherein the plurality of proxy members are identified based on a similarity value between the first skill set of the first member and a skill set of each proxy member, the similarity value calculated using a machine-learning program.

13. The system of claim 10, wherein the level of interaction between a member from the plurality of proxy members and the job is based on an aggregation of interactions of the member with the job, the interactions being one or more of the member applying for the job, the member viewing the job, or the member sharing the job.

14. The system of claim 13, wherein the job-interaction score is further based on a number of the aggregation of interactions exceeding a predetermined threshold value.

15. The system of claim 14, wherein the job-interaction score is further based on a number of proxy members being currently employed at a company.

16. The system of claim 10, wherein the job-interaction score is further based on a job affinity score, the job affinity score being a measure of a degree of matching attributes between attributes of the first member and attributes of the job.

17. The system of claim 10, wherein the plurality of proxy members is further identified based on a location of the proxy members in relation to a location of the searching member.

18. The system of claim 11, wherein the plurality of proxy members is further identified based on a comparison of a job title of each proxy member and a job title of the first member.

19. A non-transitory machine-readable storage medium comprising instructions that, when executed by one or more processors of a machine, cause the machine to perform operations comprising:
determining, by one or more processors, in response to a search for jobs for a first member of a social network, a first skill set for the first member, the first skill set being based on one or more skills identified in a profile of the first member;
identifying, by the one or more processors, a plurality of jobs presentable to the first member, each job being offered by a respective company;
identifying, by the one or more processors, a plurality of proxy members based on the proxy members having skills similar to the skills of the first member;
for each job within the plurality of jobs, calculating a job-interaction score based on a level of interaction between the plurality of proxy members and the job over a predetermined period of time;
ranking, by the one or more processors, the jobs based on the job-interaction score; and
causing presentation of the jobs in a user interface based on the ranking.

20. The non-transitory machine-readable storage medium of claim 19, wherein operations further comprise:
calculating a company trend score based on the job-interaction scores of jobs offered by a respective company;
ranking the respective companies based on the respective company trend scores; and
causing presentation of the companies in the user interface based on the ranking.
